(19) United States
(12) Patent Application Publication
(10) Pub. No.: US 2018/0285878 A1
(43) Pub. Date: Oct. 4, 2018

(54) EVALUATION CRITERION FOR FRAUD CONTROL

(71) Applicant: Microsoft Technology Licensing, LLC, Redmond, WA (US)

(72) Inventors: Harish Jayanti, Redmond, WA (US); Jayaram NM Nanduri, Issaquah, WA (US); Shoou-Jiun Wang, Sammamish (UA); Justin Hobart, Kirkland, WA (US)

(21) Appl. No.: 15/477,259

(22) Filed: Apr. 3, 2017

(51) Int. Cl. G06Q 20/40

(52) U.S. Cl. CPC G06Q 20/4016; G06Q 20/405

(57) ABSTRACT

A machine learning method for performing an efficiency analysis on a decision to accept or reject a data transaction. A machine learning classifier receives a decision analysis for data transactions, the decision analysis determining if each of the data transactions was accepted or rejected. The machine learning classifier performs an overall result analysis of a result that would occur if all true negatives and all false positives were accepted. The machine learning classifier performs an impact analysis of the false negatives on the true negatives that were properly accepted. The machine learning classifier performing an efficiency analysis by finding a ratio of the impact of the false negatives on the true negatives that were properly accepted to the result that would occur if all true negatives and all false positives were accepted.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been, and are being, developed in all shapes and sizes with varying capabilities. As such, many individuals and families alike have begun using multiple computer systems throughout a given day.

For instance, computer systems are now used in ecommerce and the like as individuals increasing perform financial transactions such as making a purchase from various vendors over the Internet. In order to perform the financial transactions, the individuals are typically required to provide a payment instrument such as a credit card or bank account information such as a checking account to the vendor over the Internet. The vendor then uses the payment instrument to complete the transaction.

The process of providing the payment instrument over the Internet leaves the various merchants subject to loss from fraudulent transactions. For example, when a fraudulent payment instrument is used to purchase a product, the merchants often loses the costs associated with the product. This is often because the bank or financial institution that issues the payment instrument holds the merchants responsible for the loss since it was the merchants who approved the transaction at the point of sale where payment instrument is not present.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One embodiment is related to a machine learning method for performing an efficiency analysis on a decision to accept or reject a data transaction. A machine learning classifier receives a decision analysis for data transactions, the decision analysis determining if each of the data transactions was accepted or rejected. The machine learning classifier performs an overall result analysis of a result that would occur if all true negatives and all false positives were accepted. The machine learning classifier performs an impact analysis of the false negatives on the p true negatives that were properly accepted. The machine learning classifier performs an efficiency analysis by finding a ratio of the impact of the false negatives on the true negatives that were properly accepted to the result that would occur if all true negatives and all false positives were accepted.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2 illustrates a computing system that may implement the embodiments disclosed herein;

FIGS. 3A and 3B illustrate an embodiment of the operation of at least some of the elements of the computing system of FIG. 3;

FIG. 4 illustrates a flow chart of an example machine learning method for performing an efficiency analysis on a decision to accept or reject a data transaction;

FIG. 5 illustrates a flow chart of an example method for determining if a data transaction is properly accepted or rejected; and

FIG. 6 illustrates a flow chart of an example method for determining an efficiency of accepting or rejecting a plurality of data transactions based on a benefit result related to each of the data transactions.

### DETAILED DESCRIPTION

Embodiments disclosed herein are related to a machine learning method for performing an efficiency analysis on a decision to accept or reject a data transaction. A machine learning classifier receives a decision analysis for data transactions, the decision analysis determining if each of the data transactions was accepted or rejected. The machine learning classifier performs an overall result analysis of a result that would occur if all true negatives and all false positives were accepted. The machine learning classifier performs an impact analysis of the false negatives on the true negatives that were properly accepted. The machine learning classifier performing an efficiency analysis by finding a ratio of the impact of the false negatives on the true negatives that were properly accepted to the result that would occur if all true negatives and all false positives were accepted.

Another embodiment is related to a computing system for determining if a data transaction is properly accepted or rejected. The computing system includes at least one processor and a computer readable hardware storage device having stored thereon computer-executable instructions which, when executed by the at least one processor, cause the computing system to perform the following: receive a plurality of data transactions, determine that a first portion of the data transactions are to be rejected, determine that a second portion of the data transactions are to be accepted, characterize each of the plurality of data transactions based on each data transaction's inclusion in the first or second portion, and evaluate if each of the plurality of data transaction was properly included in the first portion or the second portion based on one or more impact parameters related to the data transactions.

Another embodiment is related to a computing system for determining an efficiency of accepting or rejecting a plurality of data transactions based on a benefit result related to each of the data transactions. The computing system includes at least one processor and a computer readable hardware storage device having stored thereon computer-executable instructions which, when executed by the at least one processor cause the computing system to perform the following: receive a plurality of data transactions, determine a threshold based on a determined probability that each one of the data transactions should be rejected, each of the plurality of data transactions having a probability above the threshold being rejected and each one of the plurality of data transactions having a probability below the threshold being accepted, characterize each of the plurality of data transactions based on if the data transaction was rejected or accepted, determine a benefit result for each of the data transactions; and determine a benefit efficiency by calculating a ratio of an achieved benefit result to a maximum achievable benefit result for the benefit results of each of the data transactions.

One embodiment is related to e-commerce and the like. E-commerce fraud costs retailers approximately $4 billion each year. Since E-commerce is a “card not present” scenario, merchants are responsible for fraudulent loss: merchants need to return the collected fund to card issuing banks, which is known as chargeback, when card holders report the transactions are fraudulent (unauthorized usage).

To control fraud costs, traditionally, financial instruments and credit card issuing banks use chargeback rate as the measurement to evaluate the performance of Fraud Control. Since this metric penalizes missing frauds (false negatives) heavily, the strategies developed to improve chargeback rate tend to over protective and only approve very low risk transactions. As the result, many good transactions are rejected (false positives). Currently, in general, chargeback rate is lower than 1% while issuing banks reject higher than 15% of transactions. In the field of statistical classification in Machine Learning, more comprehensive measurements (e.g., accuracy, recall or false positive rate) are introduced in a table of confusion (sometimes also called a confusion matrix). Unfortunately, those measurements can be misleading when fraud attacks happen. They also do not take margin and cost of goods into the consideration, which are essential since the business goal is often to take the approach which can maximize net profit.

Some of the embodiments disclosed herein use Profit Efficiency (PE) as the standard measurement for Fraud Control. Some advantages this leads to is are: 1. Maximizing profit efficiency leads to the strategies which yield maximal profit. For goods with higher cost and lower margin, the risk enforcement is more intensive and, other the other hand, for goods with lower cost and higher margin, there is more willingness to take risk with a lighter risk enforcement. 2. Unlike other measurements which might be misleading when the business is under severe fraud attacks, profit efficiency honestly reflects the fact and shows the loss. 3. Optimizing profit efficiency is very straightforward when compared with other systems and methods.

There are various technical effects and benefits that can be achieved by implementing aspects of the disclosed embodiments. By way of example, it is now possible to use a profit margin of a transaction as a criterion for fraud detection. It is further possible to determine the ratio of an achieved benefit such as an achieved profit to a maximum achievable benefit such as a maximum achievable profit and to use this ratio to determine how efficiently data transactions are rejected and accepted. The ratio may also be used to determine how efficiently a threshold or cutoff for accepting or rejecting data transaction is. Further, the technical effects related to the disclosed embodiments can also include improved user convenience and efficiency gains.

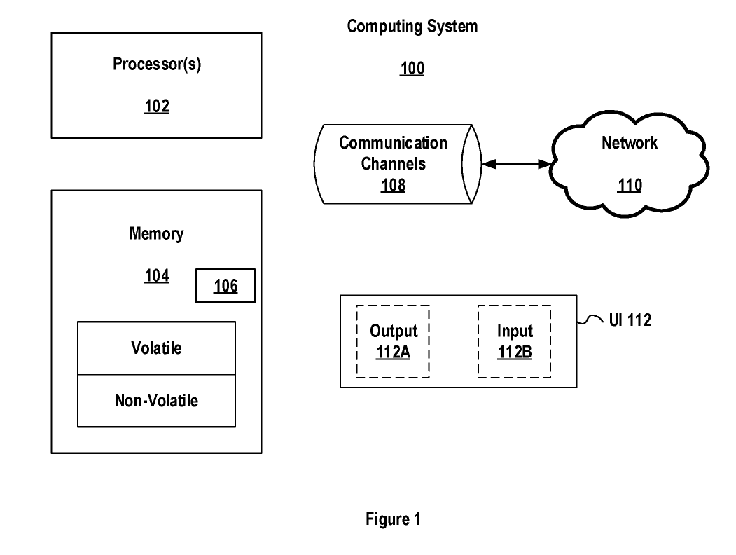

Some introductory discussion of a computing system will be described with respect to FIG. 1. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

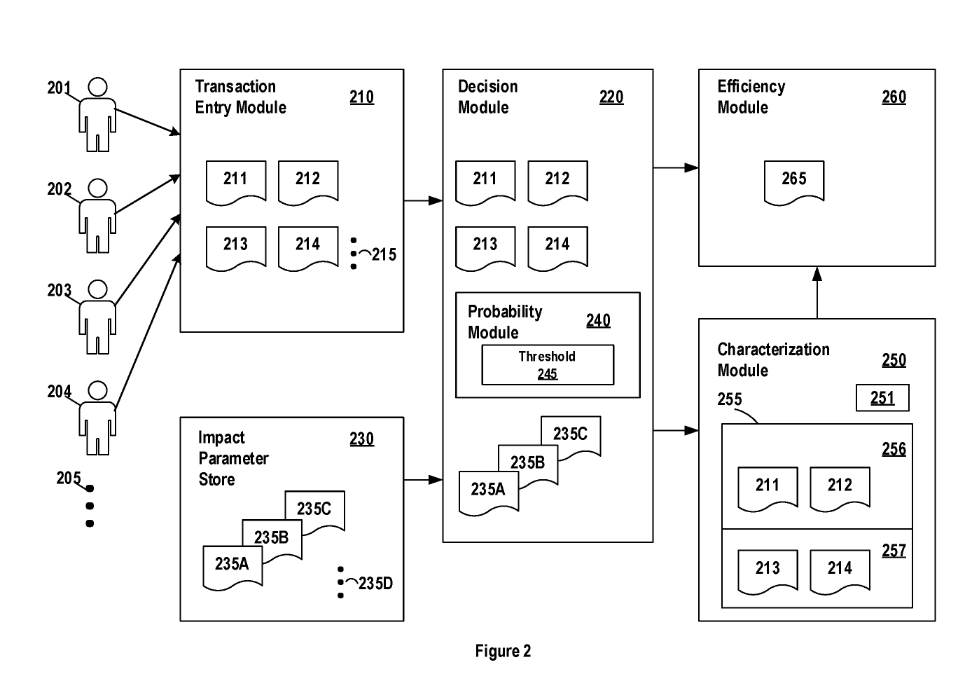

Attention is now given to FIG. 2, which illustrates an embodiment of a computing system 200, which may correspond to the computing system 100 previously described. The computing system 200 includes various components or functional blocks that may implement the various embodiments disclosed herein as will be explained. The various components or functional blocks of computing system 200 may be implemented on a local computing system or may be implemented on a distributed computing system that includes elements resident in the cloud or that implement aspects of cloud computing. The various components or functional blocks of the computing system 200 may be implemented as software, hardware, or a combination of software and hardware. The computing system 200 may include more or less than the components illustrated in FIG. 2 and some of the components may be combined as circumstances warrant. Although not necessarily illustrated, the various components of the computing system 200 may access and/or utilize a processor and memory, such as processor 102 and memory 104, as needed to perform their various functions.

As shown in FIG. 2, the computing system 200 may include a transaction entry module 210. In operation, the transaction module 210 may receive input from multiple users 201, 202, 203, 204, and any number of additional users as illustrated by the ellipses 205 to initiate a data transaction that is performed by the computing system 200. For example, the user 201 may initiate a data transaction 211, the user 202 may initiate a data transaction 212, the user 203 may initiate a data transaction 213, and the user 214 may initiate a data transaction 204. The ellipses 215 represent any number of additional data transactions that can be initiated by one or more of the users 205. Of course, it will be noted that in some embodiments a single user or a number of users less than is illustrated may initiate more than one of the transactions 211-215.

The data transactions 211-215 may represent various data transactions. For example, as will be explained in more detail to follow, the data transactions 211-215 may be purchase or other financial transactions. In another embodiments, the transactions 211-215 may be transactions related to clinical or scientific research results. In still, other embodiments, the transactions 211-215 may be any type of transaction that is able to be characterized as being properly accepted, improperly accepted, properly rejected, or improperly rejected. Accordingly, the embodiments disclosed herein are not related to any type of data transactions. Thus, the embodiments disclosed herein relate to more than purchase or financial transactions and should not be limited or analyzed as only being related to purchase or financial transactions.

The transaction entry module 210 may receive or determine information about each of the data transactions 211-215. For example, if the data transactions 211-215 are purchase or other financial transactions, then the transaction entry module 210 may determine personal information about the user, payment information such as a credit or debit card number, and perhaps the product that is being purchased. If the data transactions are clinical or scientific research data transactions, then the data transaction entry module 210 may determine identifying information about the research such as participant information and result information. The transaction entry module 210 may receive or determine other information about other types of data transactions as circumstances warrant.

The computing system 200 also includes a decision module 220. In operation, the decision module 220 may determine if each of the data transactions 211-215 is to be accepted (i.e., the data transactions are performed or completed) or if the transactions are to be rejected (i.e., the data transactions are not completed or performed). In some embodiments, the decision module 220 may perform a decision analysis on each of the data transactions. This decision analysis may be based on various factors that are indicative of whether a data transaction should be accepted or rejected.

For example, if data transaction is the purchase or other financial transaction, the factors may be related to risk analysis. For instance, the decision module 220 may determine based on the information determined by the data transaction entry module 210 that a purchase or other financial transaction is likely to be a fraudulent transaction and so the transaction may be rejected. Alternatively, this information may cause the decision module 220 to determine that the purchase or other financial transaction is likely to be a good transaction and so the transaction may be accepted.

If the data transaction is related to the clinical or scientific research results, the factors may be related to what type of errors have occurred. For example, in many research embodiments, there are Type I errors and Type II errors. The decision module 220 may accept a certain percentage of Type I errors and reject the rest and may also accept a certain percentage of Type II errors and reject the rest. In embodiments related to other types of data transactions, the decision module 220 may use other factors as circumstances warrant.

In some embodiments, the decision analysis may be based at least in part on one or more impact parameters that are related to the data transactions. For example, as illustrated in FIG. 2, the computing system may include an impact parameter store 230. Although shown as being an independent, the impact parameter store 230 may be part of another element of the computing system 200.

As shown, the impact parameter store 230 may include a first impact parameter 235a, a second impact parameter 235b, a third impact parameter 235c, and any number of additional impact parameters as illustrated by the ellipses 235d. The impact parameters may be also be referred to hereinafter as impact parameters 235.

In the embodiment related to the purchase or other financial transaction, the impact parameters 235 may be related to the product or service being purchased. For example, the first impact parameter 235a may specify a purchase price for the product or service, the second impact parameter 235b may specify the Cost of Goods Sold (COGS), and a third impact parameter 235c may specify a benefit result such as a profit margin for each transaction. As is known, the COGS typically specifies the costs of manufacturing and marketing a product as well as the cost of other factors such as customer loyalty, revenue sharing, and general business operating costs. Accordingly, the benefit result of a transaction that is properly accepted would be the purchase price minus the COGS. Other impact parameters 235d such as location of the data transaction may also be used.

Accordingly, while performing the decision analysis, the decision module 220 may base the decision at least in part on the impact parameters 235. For example, if transaction 211 includes a high purchase price and a high COGS, then the decision module 220 may be more likely to reject the transaction 211 than a data transaction 212 that has a low purchase price and low COGS. As will be noted, there is more risk to a data transaction with the high purchase price and COGS.

In the embodiment related to the to the clinical or scientific research results, the impact parameters 235 may specify the amount of error that is acceptable, the research goals, and other relevant factors. These may be used by the decision module 220 as needed. In other embodiments, various other impact parameters 235 may be used as needed by the decision module 220.

In some embodiments, the decision module 220 may include or otherwise have access to a probability module 240. In operation, the probability module 240 may, based on the decision analysis, determine the probability of whether each of the data transactions 211-215 should be rejected or not. In other words, the probability is indicative of whether a given data transaction is a good transaction that should be accepted or is a fraudulent or bad transaction that should be rejected. As will be explained in more detail, the probabilities that are determined by the probability module may be used to determine a threshold or cutoff value 245. The threshold or cutoff value 245 may be used to help determine if a data transaction is accepted or rejected. For instance, if the probability is above the threshold or cutoff value 245, then the data transaction may be rejected while if the probability is below the threshold or cutoff value, the data transaction may be accepted.

As further shown in FIG. 2, the computing system 200 includes a characterization module 250. In operation, the characterization module 250 generates a characterization 255 for each of the data transactions 211-215. As will be explained in more detail to follow, the characterization 255 may be based on whether a data transaction has been accepted or rejected and based on the actual results of the data transaction if performed or completed. That is, if a data transaction was accepted, based on the decision analysis previously described, then the data transaction may be characterized as being part of first portion or group and if the data transaction was rejected, then the data transaction may be characterized as being part of a second portion or group. This is shown in FIG. 2, where the data transactions 211 and 212 are part of a first portion or group 256 and the data transactions 213 and 214 are part of a second portion or group 257. In some embodiments, the first portion or group 211 may be above the threshold or cutoff 245 and the second portion or group may be below the threshold or cutoff 245.

In some embodiments, the characterization module may characterize the data transactions 211-215 as being one of a “true negative”, a “false negative”, a “true positive”, and a “false positive”. In such embodiments, a true negative is a data transaction that is correctly accepted, a false negative is a data transaction that was incorrectly accepted, a false positive is a data transaction that was incorrectly rejected, and a true positive is a data transaction that was correctly rejected. It will be noted that it is desirable to maximize the number of true negatives and true positives, while minimizing the number of false positives and false negatives. In those embodiments implementing the threshold or cutoff 245, good data transactions above the threshold are the false positives and below the threshold are the true negatives, while bad data transactions above the cutoff are the true positives and below the threshold are the false negatives.

As will be appreciated, those data transactions, such as data transactions 213 and 214 in the second portion or group 257, which were accepted may be performed by the computing system 200. Thus, in the embodiment where the data transactions are a purchase or other financial transaction the computing system may perform the purchase by receiving payment from the user and then providing the product to the user. In such case, the characterization module 250 is able to determine if a data transaction of the second portion 257 is a true negative if the purchase or financial transaction was properly accepted, that is if the user actually paid for the product. The characterization module 250 is also able to determine if a data transaction of the second portion 257 was a false negative, that is if the user provided a fraudulent payment instrument and did not pay.

However, since the data transactions such as data transaction 211 and 212 that are in the first portion or group 256 are rejected by decision module 220, they are not actually performed or completed by the computing system 200. Accordingly, to determine if these transactions should be characterized as false positives or true positives, the characterization module 250 may include or otherwise have access to a sampling module 251. In operation, the sampling module 251 randomly accepts a subset of the data transactions in the first portion 256 so that the data transactions in the subset are allowed to be accepted. The sampling module 251 may then sample this subset to determine the outcome of the data transaction.

For example, in the embodiment where the data transactions are a purchase or other financial transaction, the sampling module 250 may determine how many data transactions in the subset were properly completed, that is the user paid for the product. Since these were successful data transactions, they are characterized as false positives since were improperly rejected. Likewise, the sampling module 251 will determine how many data transactions in the subset were not properly completed, that is the user paid for the product by a fraudulent means. Since these data transactions were properly rejected, they are characterized as true positives. The sampling module 251 may then use statistical analysis based on the subset to characterize the remaining data transactions of the first portion 256. Since the data transactions in the first portion 256 were all rejected by the decision module 220 in the manner previously described, it is likely that many in the subset will be fraudulent transaction if they are completed. Accordingly, the subset should be only be large enough to adequately represent all of the data transactions in the first portion 256 to thereby cut down on the potential costs of the fraudulent transactions in the subset.

The computing system 200 may also include an efficiency module 260. In one embodiment, the efficiency module 260 may be a machine learning classifier that is able to employ machine learning to perform an efficiency analysis of the decision of the computing system 200 to accept or reject the data transactions 211-215. In some embodiments, the efficiency analysis may determine how efficiently each of the data transactions was included in the first and second portions 256 and 257 based at least partially on the one or more of the impact parameters 235. In other embodiments, the efficiency analysis may determine how efficiently the data transactions are accepted or rejected based on a benefit result such as the benefit result 235c and based on the threshold 245. It will be appreciated that one or more of the other components of the computing system 200 may also implement machine learning as circumstances warrant.

In operation, the efficiency module 260 may receive the impact parameters 235 and the decision analysis from the decision module 220. In addition, the efficiency module 260 may receive the characterization 255 of each of the data transactions from the characterization module 250.

The efficiency module 260 may perform an overall result analysis to determine a result that would occur if all “good” data transactions that should be accepted are accepted. In this way, the efficiency module 260 is able to ascertain the benefit of the false positives that should have been accepted, but that are rejected. For example, in the embodiment where the data transactions are purchase or other financial transactions, the benefit may be the profit obtained from the false positives and the true negatives. In the embodiment related to the clinical or scientific research results, the benefit may be results that otherwise would not have been considered.

The efficiency module 260 may also perform an impact analysis of the false negatives on the plurality of data transactions that were accepted. In some embodiments, this is done by having the efficiency module 260 subtract or otherwise remove a cost of the false positives from a benefit of the accepted true negatives. In this way, the efficiency module 260 may determine actual benefit achieved. For example, in the embodiment where the data transactions are purchase or other financial transactions, the cost of a product that was obtained fraudulently by a false negative transaction may be subtracted from the profit gained from the true negative transaction. In the embodiment related to the clinical or scientific research results, the costs of results that should not have been considered may be subtracted from the benefits of the results that should be considered.

The efficiency module 260 may also perform an efficiency analysis that finds a ratio of the impact of the false negatives on the accepted true negatives to the overall result. The resulting ratio will be an efficiency value or percentage 265 that specifies how efficiently the data transactions are rejected and accepted and how efficiently the threshold or cutoff 245 is selected. As will be appreciated, if the efficiency value or percentage 265 is a high value, it is likely the computing system is efficiently accepting and rejecting the data transactions. However, if the efficiency value or percentage 265 is a low value, it is likely the computing system is not efficiently accepting and rejecting the data transactions. In such cases, adjustments may be made to where the threshold or cutoff 245 is made.

In one embodiment, the efficiency analysis may be characterized by the following equation (1):

Benefit achieved/Maximum Benefit Achievable=Benefit (True Negative)−Cost (False Negative)/Benefit (True Negative)+Benefit (False Positive)

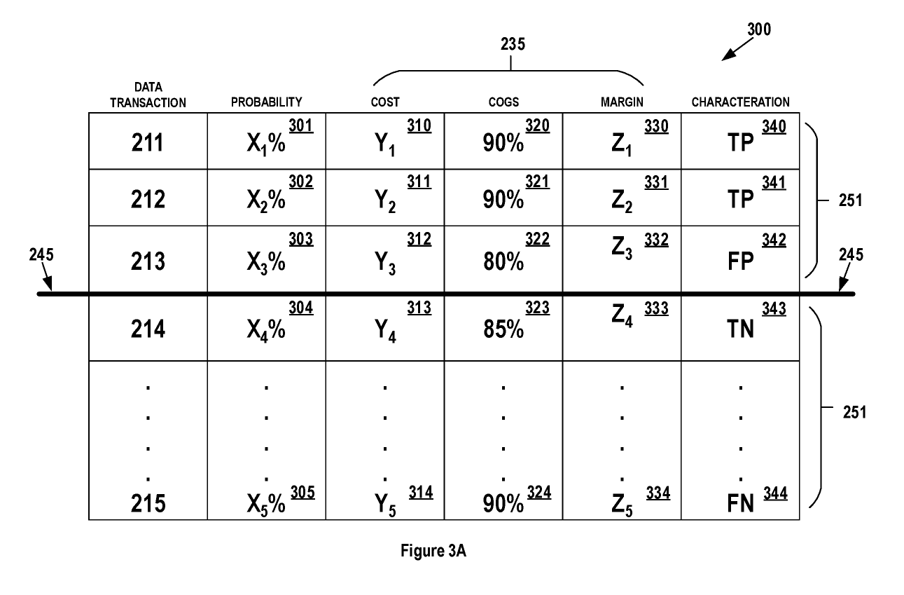

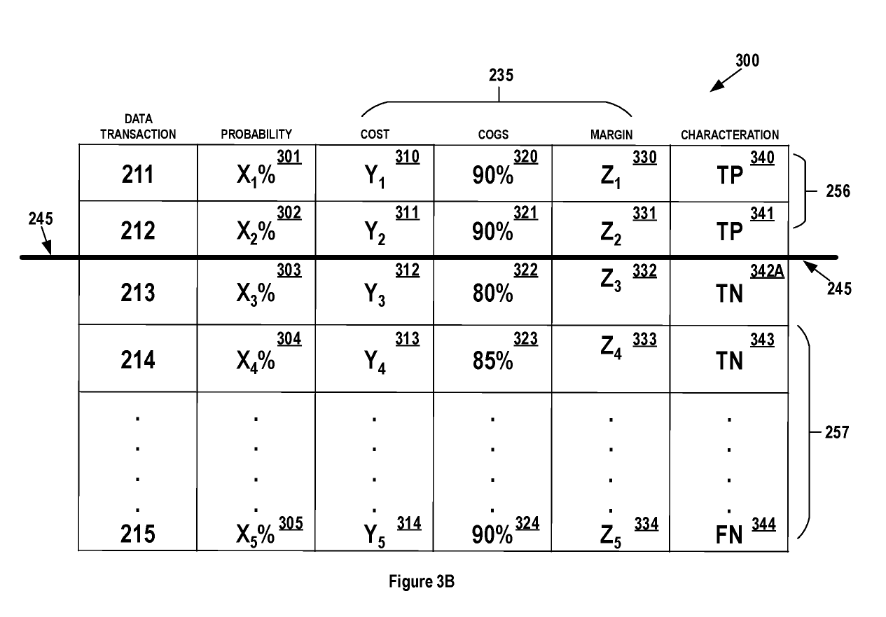

A specific example of the operation of the computing system 200 and in particular the operation of the efficiency module 260 will now be explained with reference to the embodiment of the data transactions being a purchase or other financial transaction. FIG. 3A shows a table 300 that may be used to help simply the explanation. It will be noted that the use of the table 300 for explanation purposes is not meant to imply that the computing system 200 produces such a table, although in some embodiments such a table may be produced. It will also be noted that FIG. 3A will use the same reference numbers as those used in FIG. 2 for like elements. It will further be noted that the ellipses shown in FIG. 3A represent that there will typically be a large number of data transactions in the embodiments.

As shown in FIG. 3A, the data transaction 211 was determined by the probability module 240 to have a probability 301 of X1% of being a fraudulent transaction. The data transaction 211 includes a cost 310 of Y1, a COGS 320 of 90%, and a profit margin 330 of Z1, which is determined by finding the difference between the cost 310 and the COGS 320. As described above, the cost 310, the COGS 320, and the margin 330 are examples of impact parameters 335 related to the data transaction 211. In addition, the profit margin 330 is an example of a benefit value 235c.

The data transaction 212 was determined by the probability module 240 to have a probability 302 of X2% of being a fraudulent transaction. The data transaction 212 includes a cost 311 of Y2, a COGS 321 of 90%, and a profit margin 331 of Z2, which is determined by finding the difference between the cost 311 and the COGS 321. As described above, the cost 311, the COGS 321, and the margin 331 are examples of impact parameters 335 related to the data transaction 212. In addition, the profit margin 331 is an example of a benefit value 235c.

The data transaction 213 was determined by the probability module 240 to have a probability 303 of X3% of being a fraudulent transaction. The data transaction 213 includes a cost 312 of Y3, a COGS 322 of 80%, and a profit margin 332 of Z3, which is determined by finding the difference between the cost 312 and the COGS 322. As described above, the cost 312, the COGS 322, and the margin 332 are examples of impact parameters 335 related to the data transaction 213. In addition, the profit margin 332 is an example of a benefit value 235c.

The data transaction 214 was determined by the probability module 240 to have a probability 304 of X4% of being a fraudulent transaction. The data transaction 214 includes a cost 313 of Y4, a COGS 323 of 85%, and a profit margin 333 of Z4, which is determined by finding the difference between the cost 313 and the COGS 323. As described above, the cost 313, the COGS 323, and the margin 333 are examples of impact parameters 335 related to the data transaction 214. In addition, the profit margin 333 is an example of a benefit value 235c.

The data transaction 215 was determined by the probability module 240 to have a probability 305 of X5% of being a fraudulent transaction. The data transaction 215 includes a cost 314 of Y5, a COGS 324 of 90%, and a profit margin 334 of Z5, which is determined by finding the difference between the cost 314 and the COGS 324. As described above, the cost 314, the COGS 324, and the margin 334 are examples of impact parameters 335 related to the data transaction 215. In addition, the profit margin 334 is an example of a benefit value 235c.

FIG. 3A also shows that the decision analysis of the decision module 220 determines that any transaction with a probability of X1%-X3% should be rejected, which in this case includes data transactions 211, 212, and 213. This is illustrated by the threshold or cutoff 245 being placed between data transaction 213 and 214. Accordingly, the data transactions 211-213 are included in the first portion 256 and the remaining data transactions are included in the second portion 237.

Once the threshold 245 has been determined, the characterization module 250 may characterize each of the data transactions based on if they were accepted or not in the manner previously described. In FIG. 3A, the data transaction 211 is characterized as a true positive (TP 340), the data transaction 212 is characterized as a true positive (TP 341), the data transaction 213 is characterized as a false positive (FP 342), the data transaction 214 is characterized as a true negative (TP 343), and the data transaction 215 is characterized as a false negative (FN 344).

The efficiency module 260 perform the efficiency analysis to determine how efficiently the computing system has accepted or rejected the data transactions. For example, the efficiency module 260 may determine by the overall result analysis that the overall profit achievable is margins (i.e., margin 333) of all the true negative data transactions (i.e., 214) added to the margins (i.e., margins 331 and 332) of all the false positive data transactions (i.e., 212 and 213). That is, the total profit achievable is the profit that is gained by the true negative data transactions and the profit that would have be gained had the false positive transactions not been improperly rejected.

Likewise the efficiency module 260 may determine by the impact analysis the impact of the false negatives on the accepted transactions. This may be done by subtracting the COGS of the false negative transactions (i.e., 215) from the margins (i.e., margin 333) of all the true negative data transactions (i.e., 214). That is, the costs of the false negative transactions are subtracted from the profits of the true negative transactions.

The efficiency module 260 perform the efficiency analysis to determine a ratio of the impact of the false negatives to the overall result. In the given example, the efficiency analysis may be characterized by the following equation (2):

Profit Achieved/Maximum Profit Acheivable=Margin (True Negative)−GOGS (False Negative)/Margin (True Negative)+Margin (False Positive)

The ratio will be an example of an efficiency value or percentage 265 that will specify how well the computing system has accepted or rejected the data transactions. As will be appreciated, if the value or percentage 265 is high, then the computing system is likely doing a good job of maximizing profit by accepting a large percentage of transactions that should be accepted and rejecting a large percentage of transactions that should be rejected. However, if the value or percentage 265 is low, then it is likely that the computing system is not doing a good job or maximizing profits as too many transactions that should be accepted are rejected and too many transactions that should be rejected are accepted.

FIG. 3B illustrates an example of adjusting the location of the threshold or cutoff 245 to change the profit efficiency of the computing system 200. In FIG. 3B, most of the elements are the same as that of FIG. 3A and so only the changes will be explained.

As shown, the threshold or cutoff 245 has been moved to be between the data transactions 212 and 213. The change in the threshold or cutoff 245 causes the characterization of the data transaction to become a true negative (TN 342a). That is, since the data transaction 213 is now an accepted transaction, it is a true negative since it was a good transaction that was properly accepted.

The efficiency module 260 may perform the efficiency analysis in the manner previously described. In this case, the efficiency value or percentage 265 will increase since there is no a larger profit margin associated with the true negatives.

FIGS. 3A and 3B illustrate that the efficiency module 260 is able to learn by continually evaluating how efficiently the computing system 200 determines how to accept or reject the data transactions and where to place the threshold or cutoff 245. The efficiency value or percentage 265 may be used by the efficiency module to help the computing system 200 determine where to set the threshold or cutoff. This may be tracked over a period of time so that it may ascertained if the computing system 200 is improving its maximizing of profit by accepting most of the data transactions that should be accepted and rejecting most of the data transactions that should be rejected.

In some embodiments, the embodiments disclosed herein may have different efficiency values 265 when an attack pattern changes. This section illustrates a numeric example to show how commonly used metrics and the embodiments disclosed herein reflect to a large fraud attack. In a regular day, there may be 110 fraudulent transactions attacking the computing system 200, among which, 100 are properly rejected and 10 of them are improperly accepted. When a fraud attack happens, fraudsters stress the computing system 200 by increasing attempts by 500% to improve the successes by 50%. This illustrates a typical fraud attack in the real world. Assuming the good traffic remains the same, in the following table 1, it can seen: false positive rate (FPR) doesn't change, Precision, Recall and Accuracy have more favorite values while chargeback rate and the embodiments disclosed herein, shown as PE ratio, are less favorite. It will be noted that FPR, Precision, Recall, Accuracy, and chargeback rate are examples of comparative methods.

As shown, Precision, Recall and Accuracy are more sensitive in reflecting the number of fraudulent transactions caught (for the additional 505 attempts, 500 or 99.01% are caught comparing with the regular attack where 100 out of 110 or 90.91% are caught), while Chargeback rate and PE ratio tend to reflect the fact that the number of approved bad transactions has increased from 10 to 15 which causes additional loss.

If a monthly measurement is picked for performance index and assuming a “regular” month followed by an “under attack” month, it would be far from desirable to report a positive trend (which Precision, Recall and Accuracy will do) when the loss does increase substantially. Focusing on the bright side that more fraudulent attempts are caught is not very convincing since it does not correctly reflect the business concerns. However, using Chargeback Rate as the key performance index leads to a very conservative strategy of approving transactions since, by definition, it almost does not penalize false positives in the field of Fraud Control where large majority of approved transactions are good. The embodiments disclosed herein provide a metric which takes both false positives and false negatives into account and successfully reports the trend which business desires to see, not even mentioning its major advantage of driving strategies which are willing to take more risk on low cost goods and more conservative on high cost ones.

TABLE 1

| | | A Regular Day | Under Attack |
|---|---|---|---|
| TN | Approved Good Txns | 1000 | 1000 |
| FP | Rejected Good Txns | 5 | 5 |
| TP | Rejected Bad Txns | 100 | 600 |
| FN | Approved Bad Txns | 10 | 15 |
| | Chargeback Rate | 0.99% | 1.48% |
| | FPR | 0.50% | 0.50% |
| | Precision | 95.24% | 99.17% |
| | Recall | 90.91% | 97.56% |
| | Accuracy | 98.65% | 98.77% |
| | PE Ratio (assuming 50% margin) | 98.51% | 98.01% |

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

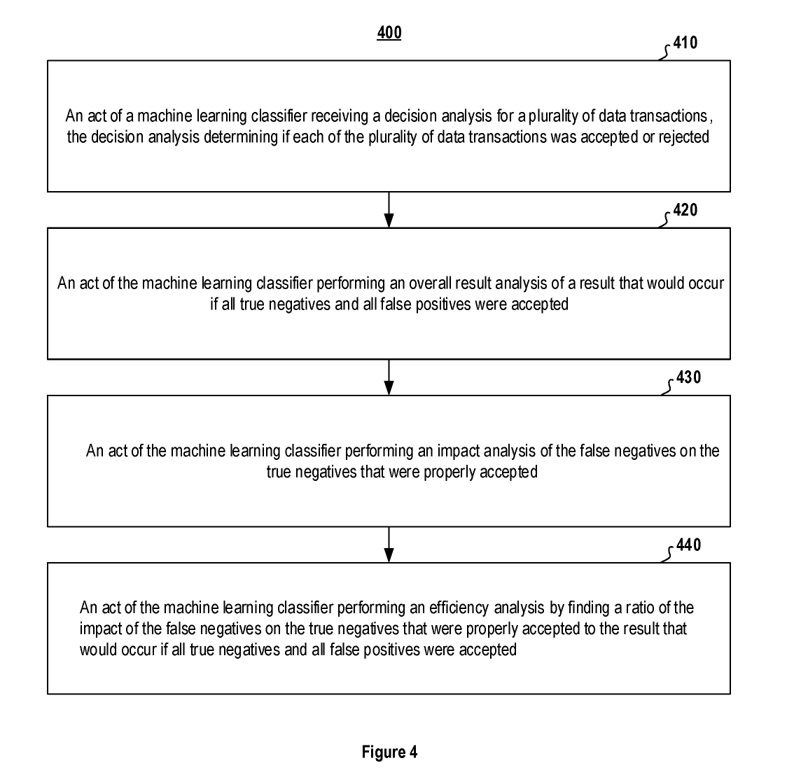

FIG. 4 illustrates a flow chart of an example machine learning method 400 for performing an efficiency analysis on a decision to accept or reject a data transaction. The method 400 will be described with respect to one or more of FIGS. 2-3B discussed previously.

The method 400 includes a machine learning classifier receiving a decision analysis for a plurality of data transactions (act 410). The decision analysis determines if each of the plurality of data transactions was accepted or rejected. A false negative is one of the plurality of data transactions that should have been rejected but was instead accepted, a false positive is one of the plurality of data transactions that should have been accepted but was instead rejected, and a true negative is one of the plurality of data transactions that was properly accepted.

For example, as previously described the efficiency module 260 may receive the decision analysis from the decision module 220. The decision analysis may determine if the data transactions 211-214 should be accepted or rejected in the manner previously described.

The method 400 includes the machine learning classifier performing an overall result analysis of a result that would occur if all true negatives and all false positives were accepted (act 420). For example, in the manner previously described the efficiency module 260 may determine the maximum achievable benefit that would occur if all “good” data transactions that should be accepted were accepted. In some embodiments, the efficiency module determines a maximum achievable profit.

The method 400 includes the machine learning classifier performing an impact analysis of the false negatives on the plurality of data transactions that were accepted (act 430). For example, in the manner previously described the efficiency module 260 may subtract or otherwise remove a cost of the false positives from a benefit of the accepted true negatives. In some embodiments, the cost of a product that was obtained fraudulently by a false negative transaction may be subtracted from the profit gained from the true negative transaction.

The method 400 may include the machine learning classifier performing an efficiency analysis by finding a ratio of the impact of the false negatives on the true negatives that were properly accepted to the result that would occur if all true negatives and all false positives were accepted (act 440). For example, in the manner previously described the efficiency module 260 may determine the efficiency value or percentage 265 that specifies how efficiently the data transactions are rejected and accepted and how efficiently the threshold or cutoff 245 is selected.

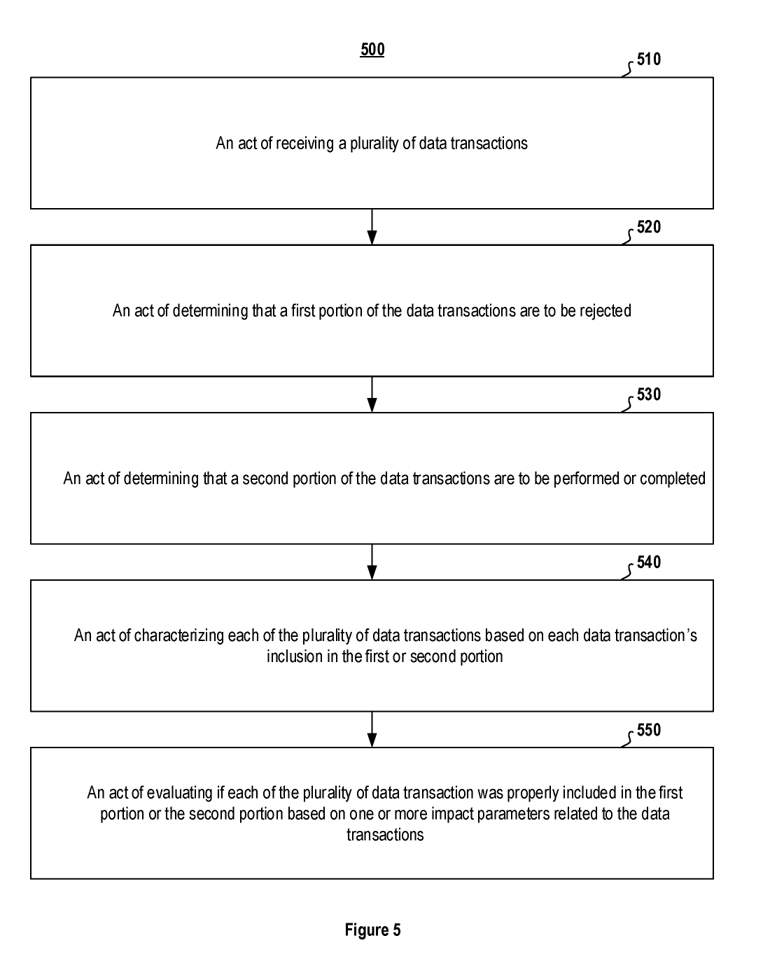

FIG. 5 illustrates a flow chart of an example method 500 for determining if a data transaction is properly accepted or rejected. The method 500 will be described with respect to one or more of FIGS. 2-3B discussed previously.

The method 500 includes receiving a plurality of data transactions (act 510). For example as previously described the computing system 200, specifically the transaction entry module 210, receives the data transactions 211-215. These data transactions may be any type of data transaction.

The method 500 includes determining that a first portion of the data transactions are to be rejected (act 520) and determining that a second portion of the data transactions are to be accepted (act 530). For example, as previously described the decision module 220 may determine that some of the data transactions 211-215 are to be rejected as part of the first portion 256 and that rest of the data transactions are to accepted as part of the second portion 257.

The method 500 includes characterizing each of the plurality of data transactions based on each data transaction's inclusion in the first or second portion (act 540). For example, as previously described the characterization module 250 may generate the characterization 255 based on if the data transactions are rejected or accepted. The characterization may be based on the position of the threshold or cutoff 245. In some embodiments, the data transactions may be characterized as one of a true negative, a true positive, a false negative, or a false positive.

The method 500 includes evaluating if each of the plurality of data transactions was properly included in the first portion or the second portion based on one or more impact parameters related to the data transactions (act 550). For example, as previously described the efficiency module 260 may perform the efficiency analysis. In some embodiments, the efficiency analysis may use one or more of the impact parameters 235, such as the benefit parameter 235c.

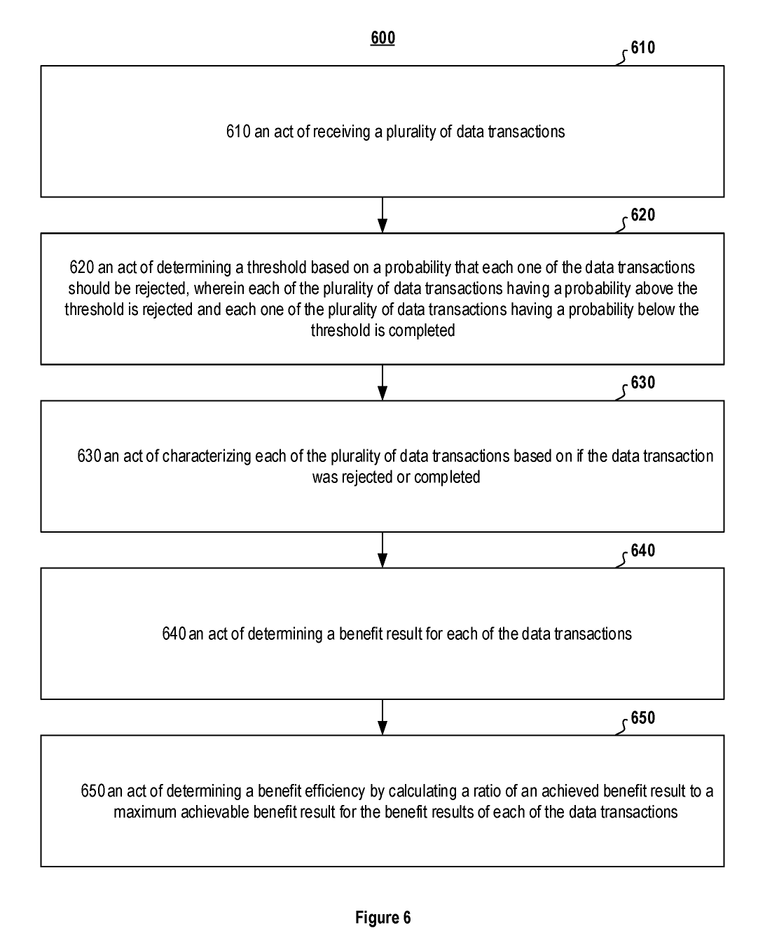

FIG. 6 illustrates a flow chart of an example method 600 for determining an efficiency of accepting or rejecting a plurality of data transactions based on a benefit result related to each of the data transactions. The method 600 will be described with respect to one or more of FIGS. 2-3B discussed previously.

The method 600 includes receiving a plurality of data transactions (act 610). For example as previously described the computing system 200, specifically the transaction entry module 210, receives the data transactions 211-215. These data transactions may be any type of data transaction.

The method 600 includes determining a threshold based on a determined probability that each one of the data transactions should be rejected (act 620). Each of the plurality of data transactions having a probability above the threshold is rejected and each one of the plurality of data transactions having a probability below the threshold is accepted. For example, as previously described the probability module 240 may determine the probability of whether each of the data transactions 211-215 should be rejected or not. The probability is indicative of whether a given data transaction is a good transaction that should be accepted or is a fraudulent or bad transaction that should be rejected. The threshold or cutoff 245 may be determined and all data transactions having probabilities above the threshold may be rejected while all data transactions having probabilities below the threshold may be accepted.

The method 600 includes characterizing each of the plurality of data transactions based on if the data transaction was rejected or accepted (act 630). For example, as previously described the characterization module 250 may generate the characterization 255 based on if the data transactions are rejected or accepted. The characterization may be based on the position of the threshold or cutoff 245. In some embodiments, the data transactions may be characterized as one of a true negative, a true positive, a false negative, or a false positive.

The method 600 includes determining a benefit result for each of the data transactions (act 640). For example, as previously described a benefit value 235c, which is one of the impact parameters 235, may be determined for each of the data transactions 211-215. In some embodiments, the benefit value may be a profit margin for the data transaction.

The method 600 includes determining a benefit efficiency by calculating a ratio of an achieved benefit result to a maximum achievable benefit result for the benefit results of each of the data transactions (act 650). For example, as previously described the efficiency module 260 may use equation 1 or equation 2 to determine the efficiency value 265. The efficiency value may then be used to determine if the threshold or cutoff 245 is properly located as described in relation to FIGS. 3A and 3B.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A machine learning method for performing an efficiency analysis on a decision to accept or reject a data transaction, the machine learning method comprising:
an act of a machine learning classifier receiving a decision analysis for a plurality of data transactions, the decision analysis determining if each of the plurality of data transactions was accepted or rejected, wherein a false negative is one of the plurality of data transactions that should have been rejected but was instead accepted, a false positive is one of the plurality of data transactions that should have been accepted but was instead rejected, and a true negative is one of the plurality of data transactions that was properly accepted;
an of the machine learning classifier performing an overall result analysis of a result that would occur if all true negatives and all false positives were accepted;
an act of the machine learning classifier performing an impact analysis of the false negatives on the true negatives that were properly accepted; and
an act of the machine learning classifier performing an efficiency analysis by finding a ratio of the impact of the false negatives on the true negatives that were accepted to the result that would occur if all true negatives and all false positives were accepted.

2. The machine learning method of claim 1, wherein the plurality of data transactions are transactions that are able to be characterized as being properly accepted, improperly accepted, properly rejected, or improperly rejected.

3. The machine learning method of claim 1, wherein performing an overall result analysis of a result that would occur if all true negatives and all false positives were accepted comprises determining a maximum achievable benefit.

4. The machine learning method of claim 3, wherein the determination of the maximum achievable benefit uses a benefit value impact parameter.

5. The machine learning method of claim 1, wherein performing an impact analysis of the false negatives on the plurality of data transactions that were accepted comprises removing a cost of the false positives from a benefit of the accepted true negatives.

6. The machine learning method of claim 1, wherein the ratio of the impact of the false negatives on the true negatives that were properly accepted to the result that would occur if all true negatives and all false positives were accepted is an efficiency value or percentage that specifies how efficiently the data transactions are rejected and accepted.

7. A computing system for determining if a data transaction is properly accepted or rejected, the computing system comprising:
at least one processor;
a computer readable hardware storage device having stored thereon computer-executable instructions which, when executed by the at least one processor, cause the computing system to perform the following:
an act of receiving a plurality of data transactions;
an act of determining that a first portion of the data transactions are to be rejected;
an act of determining that a second portion of the data transactions are to be accepted;
an act of characterizing each of the plurality of data transactions based on each data transactions inclusion in the first or second portion; and
an act of evaluating if each of the plurality of data transaction was properly included in the first portion or the second portion based on one or more impact parameters related to the data transactions.

8. The computing system of claim 7, wherein the plurality of data transactions are transactions that are able to be characterized as being properly accepted, improperly accepted, properly rejected, or improperly rejected.

9. The computing system of claim 7, wherein the first portion of data transactions are above a threshold or cutoff.

10. The computing system of claim 7, wherein the second portion of data transactions are below a threshold or cutoff.

11. The computing system of claim 7, wherein the data transactions are characterized as one of a true negative, a false negative, a true positive, and a false positive.

12. The computing system of claim 7, wherein evaluating if each of the plurality of data transaction was properly included in the first portion or the second portion based on one or more impact parameters related to the data transactions comprises:
determining a benefit efficiency by determining a ratio of a benefit achieved to a maximum benefit achievable.

13. The computing system of claim 12, wherein the one or more impact parameters are used in the determination of the ratio of a benefit achieved to a maximum benefit achievable.

14. The computing system of claim 7, wherein the one or more impact parameters are one of a profit margin, a cost of goods sold, a product cost.

15. A computing system for determining an efficiency of accepting or rejecting a plurality of data transactions based on a benefit result related to each of the data transactions, the computing system comprising:
at least one processor;
a computer readable hardware storage device having stored thereon computer-executable instructions which, when executed by the at least one processor, cause the computing system to perform the following:
an act of receiving a plurality of data transactions;
an act of determining a threshold based on a probability that each one of the data transactions should be rejected, wherein each of the plurality of data transactions having a probability above the threshold is rejected and each one of the plurality of data transactions having a probability below the threshold is accepted;
an act of characterizing each of the plurality of data transactions based on if the data transaction was rejected or accepted;
an act of determining a benefit result for each of the data transactions; and
an act of determining a benefit efficiency by calculating a ratio of an achieved benefit result to a maximum achievable benefit result for the benefit results of each of the data transactions.

16. The computing system of claim 15, further comprising determining the probability that each one of the plurality of data transactions is a transaction that should be rejected.

17. The computing system of claim 15, wherein the plurality of data transactions are transactions that are able to be characterized as being properly accepted, improperly accepted, properly rejected, or improperly rejected.

18. The computing system of claim 15, wherein the benefit result is a profit margin for each of the data transactions.

19. The computing system of claim 15, wherein the act of determining a benefit efficiency by calculating a ratio of an achieved benefit result to a maximum achievable benefit result for the benefit results of each of the data transactions comprises:
determining a profit margin for each properly accepted data transaction;
subtracting a cost of each improperly accepted transaction from the profit margin of the properly accepted transactions; and
dividing by the sum of the profit margin for each properly accepted data transaction and a profit margin for each improperly rejected data transaction.

20. The computing system of claim 15, wherein the data transactions are characterized as one of a true negative, a false negative, a true positive, and a false positive.
